(19) United States
(12) Patent Application Publication
(10) Pub. No.: US 2026/0191242 A1
(43) Pub. Date: Jul. 9, 2026

(54) VEGAN-BASED WHOLE EGG SUBSTITUTE PRODUCT

(71) Applicant: NEGGST FOODS GMBH, Berlin (DE)

(72) Inventors: Veronica GARCIA ARTEAGA, Berlin (DE); Jana Frederike CZERWINSKE, Berlin (DE); Siegfried FÜRTAUER, Aachen (DE); Bernhard VAN LENGERICH, Plymouth, MN (US)

(21) Appl. No.: 19/131,759

(22) PCT Filed: Nov. 24, 2022
(86) PCT No.: PCT/EP2022/083154

§ 371 Date: May 21, 2025

(51) Int. Cl. A23L 15/00; A23L 27/30; A23L 27/40; A23L 29/212; A23L 29/262; A23L 33/155; A23L 33/185

(52) U.S. Cl. CPC A23L 15/35; A23L 27/33; A23L 27/40; A23L 29/212; A23L 29/262; A23L 33/155; A23L 33/185

(57) ABSTRACT

The invention relates to a vegan-based whole egg substitute product comprising a mixture of (a) 1.0 wt. %-30.0 wt. % of one or more proteins from pulses, oilseeds, cereals, algae, or microorganisms; (b) 1.0 wt. %-30.0 wt. % of vegetable oil optionally containing at least one emulsifier; (c) 0.2 wt. %-5 wt. % of a combination of one or more reversibly thermogelling hydrocolloid(s) with one or more reversibly gelling hydrocolloid(s); (d) 2.0 wt. %-15 wt. % of at least one carotenoid-containing food and/or a natural coloring substance; and (e) optionally at least one partially pregelatinized starch; (f) 0.2 wt. %-2.0 wt. % salt; (g) with the rest being drinking water. The invention also relates to a method for producing the whole egg substitute product and the use of the whole egg substitute product to produce an emulsion, in a meal or bakery product.

### FIELD OF APPLICATION

The invention relates to a vegan-based whole egg substitute product.

### PRIOR ART

Awareness of the importance of a sustainable lifestyle also continually increases the significance of a purely plant-based diet. In addition to pure vegans and vegetarians, more and more people are trying to reduce the consumption of animal products (flexitarians and flexiganians). The latter leads to an increasing demand for and availability of plant-based foods that offer consumers a similar taste experience to that of the corresponding animal products.

Eggs are a high-quality source of protein and, in addition to direct consumption, perform many tasks in food such as forming emulsions and foams and stabilizing dough masses. Due to the wide range of possible uses, a vegan alternative for eggs which covers as many areas as possible is a major challenge.

Chicken egg yolk is a fat-in-water emulsion and contains about 30% fat, about 17% proteins, minerals, and vitamins in addition to just under 50% water. Due to the high content of phospholipids (about 30% of the fat), egg yolk is a very good emulsifier, the carotenoids contained therein lead to the characteristic yellow-orange color.

In the kitchen, egg yolk is mainly used as an emulsifier (for example for mayonnaises), for loosening, foaming, and thickening creams, and for stabilizing crumbs in bakery products. Egg yolk solidifies when heated above 72° C.

Chicken egg white makes up 55-60% of the total egg weight. In addition to 80-84% water, egg white contains 12% protein, 0.7% carbohydrates, 0.7% minerals and 0.03% lipids. Depending on the freshness of the product, egg white has a pH of 7.6 to 9.7; the pH increases during storage due to the diffusion of CO₂ through the egg shell. Egg white contains various proteins: ovalbumin (54%), conalbumin (12%), ovomucoid (11%), and ovomucin (3.5%). Owing to its protein content and high-quality amino acid composition, egg white of animal origin is an important source of protein.

It has all amino acids essential for humans and therefore has a high protein value.

WO 2017/014967 A1 and WO 2017/014806 A1 relate to plant-based egg substitute compositions which are characterized by a high content of hydrocolloids.

WO 2019/220431 A1 also relates to egg substitute compositions which have more than 5% hydrocolloids.

WO 89/10704 relates to an egg substitute in which the egg yolk substitute is surrounded by a membrane and is combined with a natural protein or a treated protein or a protein analog.

There are already various other egg substitute products, the basis of which is usually a mixture of starches and hydrocolloids, in some cases also of vegetable proteins (US 2013/0084361 A1; DE 603 13 732 T2). They can be used as dry or liquid products in foods where they largely or partially take over the functions of egg (comparable color, thickening). Some of these products also have a rheology similar to animal egg.

### OBJECT OF THE PRESENT INVENTION

The object of the present invention is to provide a whole egg-like food on a vegan basis without the liquid phases solidifying. This food product should be able to be processed analogously to animal egg, i.e., to form and stabilize emulsions and solidify on heating.

### DESCRIPTION OF THE INVENTION

The object is achieved by a whole egg substitute product comprising a mixture of:
(a) 1.0 wt. %-30.0 wt. % of one or more proteins derived from pulses, oilseeds, cereals, algae, or microorganisms;
(b) 1.0 wt. %-30.0 wt. % of vegetable oil, optionally containing at least one emulsifier;
(c) 0.2 wt. %-5 wt. % of a combination of one or more reversibly thermogelling hydrocolloid(s) with one or more reversibly gelling hydrocolloid(s);
(d) 2.0 wt. %-15 wt. % of at least one carotenoid-containing food and/or a natural coloring substance;
(e) optionally at least one partially pregelatinized starch
(f) 0.2 wt. %-2.0 wt. % of salt; and
(g) the rest being drinking water.

The percentages mentioned in the following text are in each case wt. %. ‘Vegan-based’ means that the product does not contain any animal or animal-derived ingredients.

The product according to the invention preferably has a protein content of between 1% and 30%, very advantageously between 4% and 25%, and particularly advantageously between 5% and 20%. Suitable sources of protein are vegetable raw materials from the group of pulses, cereals, oilseeds, (micro) algae, and microorganisms, preferably peas (Pisum sativum), chickpeas (Cicer arientinum), garden beans (Phaseolus vulgaris), fava beans (Vicia faba), sweet lupins (Lupinus), lentils (Lens culinaris), corn (Zea nays), hemp (Cannabis sativa), yams (Ipomoea batatas), manioc (Manihot esculenta), table potatoes (Solanum tuberosuin), pumpkin (Cucurbita), flax (Linum usitatissimum), rapeseed (Brassica napus), soy (Glycine max), oats (Avena sativa), duckweed (Lemna), bacteria (e.g., Lactobacillus spp., Streptococcus spp., and Bifidobacterium spp.), yeasts (e.g., Saccharomyces cerevisiae), molds (e.g., Aspergillus spp., Mucor spp., and Rhizopus spp.), nori algae and/or wakame algae, wherein pea, lupin, potato, chickpea, and fava bean proteins are particularly advantageous. Preference is given to a proportion of 2.0%-8.0% of fava bean protein and 2.0%-15% of pea protein, more preferably 1.5%-2.5% (very preferably about 2.0%) of fava bean protein and 2.5%-3.5% (very preferably about 3.25%) of pea protein. The protein source used may be (crude and/or hydrolyzed and/or fermented) flours, protein concentrates, protein isolates, and/or any desired combinations thereof which can be obtained from the plants and parts of plants per se, their seeds, tubers, and/or fruits of the abovementioned raw materials. A person skilled in the art in the field of food technology is sufficiently aware of the processing and nutritional suitability of the plants and respective plant parts.

In some embodiments, transglutaminases may optionally be added to improve the texture of the protein solutions or emulsions. The effect of transglutaminases on texture lies in their ability to promote crosslinking of proteins at certain temperatures and time conditions. The amount of transglutaminases is preferably between 0.001% and 3.00%, more preferably 0.01%-1.5%, still more preferably 0.1%-1.0%. The transglutaminases are activated while the protein solution or emulsion is heated to temperatures between 40° C.-60° C. for at least 15 minutes, preferably 30 minutes, 60 minutes, 90 minutes, or 120 minutes. The transglutaminase may, but need not, be microencapsulated and can preferably be inactivated during the preparation of the egg substitute product by pasteurization or UHT treatment (above 75° C. or 120° C.).

The fat content is preferably between 1% and 30%, more preferably 3-20%, very advantageously between 5% and 12% and particularly advantageously between 7% and 10%. Suitable fatty components are vegetable oils, for example olive oil, coconut oil, linseed oil, walnut oil, safflower oil, and/or peanut oil; however, taste-neutral oils such as rapeseed oil, sunflower oil, and/or corn germ oil are preferred. The use of 3.0%-20.0%, more preferably 7.0-10.0%, very preferably about 8.0%, of sunflower oil, and/or rapeseed oil is preferred. Advantageously, up to 30%, preferably 5-12%, more preferably 7-10%, based on the proportion of the fat component, of emulsifiers may be added to the fat component. These are, for example, (vegetable) lecithin (or ingredients thereof, such as phosphatidylcholine, phosphatidylserine, phosphatidylethanolamine, or phosphatidylinositol), ascorbyl palmitate, sodium phosphate, sodium pyrophosphate, potassium phosphate, propylene glycol alginate, polyoxyethyl stearate, ammonium phosphatides, acetic acid monoglycerides, lactic acid monoglycerides, citric acid monoglycerides, tartaric acid monoglycerides, stearyl tartrate, or sorbitan monostearate.

In order to give the egg substitute product the appropriate color, at least one carotenoid-containing food and/or a natural coloring substance are added as a further ingredient. Preparations of fruits, vegetables, and tubers, advantageously of tuber and root vegetables, for example of carrots, apricots, tomatoes, peppers, pumpkin, fennel, and/or yam, are suitable for this purpose. These are preferably cooked and processed into porridge or finely chopped. In some embodiments, the amount of carotenoid-containing foods in the egg is less than 15.0% (e.g., less than 12.0%, less than 8.00%, less than 4.00%, less than 2.00%, less than 1.50%, or less than 0.50%). In some embodiments, the amount of carotenoid-containing foods in the egg is 0.01%-10.0% (e.g., 0.50%-9.50%, 2.50%-7.50% or 3.00%-5.50%). It has been found that the use of yams in particular as a carotenoid-containing food surprisingly leads to the formation of a texture and color very similar to the classic egg yolk, wherein the use of yams also supports the protein content and fiber content and brings a starch component into the mixture, which has an advantageous effect on the texture. These are preferably cooked and processed into porridge or finely chopped. The amount of yams can be between 2% and 10%, advantageously between 3% and 8%. A proportion of 5.0%-6.0% is overall preferred, more preferably about 5.7%. In the case of yam as a carotenoid-containing food, further addition of an at least partially pregelatinized starch is unnecessary (0%) or can be limited to a small amount of less than 0.5%. Otherwise, addition of at least one (partially) pregelatinized starch is advisable, preferably in an amount of 0.5%-4%, more preferably 1.0%-3.0%. (Partially) pregelatinized starch is preferably obtained from corn starch, potato starch, or rice starch by mechanical processing in the presence of water with or without the use of heat. Some or all of the starch cereals burst. The powder is then dried. Pre-gelatinized starch is a white to yellowish white powder that swells in cold water. It has good rheological properties and is suitable as a binder.

Other suitable preparations of fruits, vegetables, and tubers can optionally be used to adjust texture, mouthfeel, and color. The addition of preferably fat-soluble natural coloring substances such as carotenoids (e.g., β-carotene, lycopene, zeaxanthin), carrot extracts, curcumin, and dyes poorly soluble in water, such as riboflavin, is also suitable for optimum color adjustment. These are used individually or in combination to achieve the desired hue. In some embodiments, the amount of natural coloring substances in the egg is less than 2.00% (e.g., less than 1.50%, less than 1.00%, less than 0.75%, or less than 0.25%). In some embodiments, the amount of natural coloring substances in the egg yolk is 0.01%-2.00% (e.g., 0.25%-1.75%, 1.00%-0.50%, or 1.75%-0.25%). In a preferred embodiment, the proportion of β-carotene and/or carrot extract is 0.05%-1.25%, very preferably about 0.07%. The egg color can range from yellow to dark orange in the Lab*a*b* color space. The brightness (L*) can range from 70-85, advantageously from 75-80: the red-green (a*) can range from 15-30, advantageously from 19-25; the yellow-blue (b*) can range from 60-95, advantageously from 70-90, particularly advantageously from 75-88.

Salt is added to produce a chicken egg-like aroma, preferably NaCl, KCl, NaH₂PO₄, Na₂HPO₄, Na or K citrate, Ca lactate, CaCl₂), Na₃PO₄, and/or Kala-Namak (black salt) or a salt comparable to Kala-Namak which has a proportion of sulfur compounds. For this purpose, the amount of salt, preferably Kala-Namak salt, is less than 2.00%. e.g., less than 0.75%, less than 0.50%, less than 0.25%, or less than 0.10% in some embodiments. In a preferred embodiment, the egg substitute product contains 0.2% to 0.5% NaCl (preferably about 0.375%) and optionally additionally up to 1.0% Ca lactate and/or up to 1.5% KCl (preferably about 0.03%).

The egg substitute product may optionally also contain small amounts (less than 10.0%, preferably less than 5%, 3% or 2%) of additional secondary components. These can be flavoring formulations, spices, dried vegetables or fruits, sugars, preservatives, thickeners, or health-promoting additives. Examples which may be mentioned here are iodine, vitamins (e.g., vitamin B₁, B₂, B₃, B₅, B₇, B₉, B₁₂, C, D₃, or E), minerals (e.g., Ca or Mg) or plant lecithin (also acts as an emulsifier). In a preferred embodiment, vitamin D3 (0-0.001%, preferably about 0.000001%) and/or vitamin B12 (0-0.0005%, preferably about 0.0000005%), and/or a natural flavorings (0-2.5%, preferably about 0.4%) and/or dextrose (0-1.5%, preferably about 0.02%) are optionally added as secondary components.

For the adjustment of the desired viscosity and the solidification during heating, the egg substitute product contains hydrocolloids. A combination of one or more thermogelling hydrocolloids with one or more reversibly gelling hydrocolloids has proven to be advantageous, wherein the two types differ in their behavior in the event of temperature changes. The hydrocolloids which gel rapidly when the temperature is raised to >40° C. are called “thermogelling” or “thermoreversible gel-forming” and are preferably modified celluloses, preferably methylcelluloses, hydroxyethylcelluloses, and/or hydroxypropylcelluloses. However, the gelling brought about in this way is only temporary: upon cooling to <40°, the gel is converted back into the original viscous solution. To produce thermogelling, there should be a certain minimum concentration of thermogelling hydrocolloids, which is about 1.5 g/l in the case of methylcelluloses. A person skilled in the art can determine the minimum concentration for other thermogelling hydrocolloids without great experimental expenditure. Below this concentration, no gelling takes place when the aqueous solution is heated. Reversibly gelling hydrocolloids form gels at room temperature (about 20° C.) which, in contrast to the thermogelling hydrocolloids, melt on heating within a specific temperature interval, i.e., liquefy and form a viscous solution which, in turn, gels again after cooling to or below the gelling temperature. The reversibly gelling hydrocolloids used are those from algae, preferably carrageen and/or agar. Other hydrocolloids are additionally used to adjust the desired consistency and support the permanent solidification of the vegan egg, preferably gellan gum, locust bean gum, guar gum, alginate, and/or xanthan. In some embodiments, the amount of hydrocolloids in the egg substitute product is less than 5.00% (e.g., less than 4.75%, 4.50%, 4.25%, 4.00%, 3.75%, 3.50%, 3.25%, 3.00%, 2.75%, 2.50%, 2.25%, 2.00%, 1.75%, 1.50%, 1.00%, 0.75% or equal to or less than 0.50%). In some embodiments, the amount of hydrocolloids in the egg substitute product is 0.20%-5.00%, 0.25%-3.00%, 0.50%-2.50%, or 0.75%-2.00%. In a preferred embodiment, the egg substitute product contains 0.1-2.5% (preferably about 1.0%) methylcellulose and 0.1-2.5% (preferably about 0.9%) carrageen. Xanthan can be present as an additional hydrocolloid in an amount of up to 2.5% (preferably about 0.05%). The division between thermogelling and reversibly gelling hydrocolloids is preferably 50:50, preferably 25:75, 30:70, respectively, or 40:60 or 75:25, 70:30 or 60:40, respectively. A quantity of hydrocolloids of less than 5.00% allows the provision of a liquid raw egg substitute, but on the other hand provides stability and texture, comparable to a chicken egg, when flying, baking, or cooking.

According to the invention, the protein source is dispersed in water or an aqueous salt solution (solution (A)). Solution (A) can be divided into two parts ((A1) and (A2)). However, it is also possible to prepare two solutions (A1) and (A2) independently of one another: (A1) can be an aqueous protein or protein-salt solution and (A2) can be a solution of another protein or just water. Optionally, 0.001%-2.00% transglutaminase can be added to solution (A1). If unencapsulated transglutaminase is used, the solution should be maintained at 50° C. for less than 120 minutes. Solution (B) is prepared by heating solution (A1) to at least 40° C., preferably 50° C., but not more than 60° C., and adding one or more thermogelling hydrocolloids (e.g., modified cellulose, methylcellulose, and/or hydroxypropylcellulose). The effect of heat results in an improved dispersion of the hydrocolloids. Before or after dispersion of the hydrocolloids, oil (optionally containing 0.01%-50% emulsifiers), optionally a calcium ion source, carotenoid-containing foods, or natural coloring substances and optionally further additives are mixed in solution (B). Solution (C) is prepared by mixing solution (A2) with one or more reversibly gelling hydrocolloids at a temperature below 30° C., preferably below 20° C., 15° C., or 10° C. In addition, natural flavorings, flavoring formulations, oil, and (encapsulated) transglutaminase or other additives can be mixed in solution (C). As soon as all the components of the solutions (B) and (C) are completely dispersed, the solutions (B) and (C) are mixed at a temperature preferably below 30° C., as a result of which the finished egg solution (solution (D)) is formed. The above-described solutions and dispersions are prepared in standard mixing vessels using known dispersion techniques.

The mixture (solution (D)) can be homogenized to achieve a complete and fine distribution of the oil particles. Surprisingly, this improved both the mouthfeel, such that no more roughness was noticeable on the tongue, and the brightness, such that fewer dyes were needed for coloring and that the product had a stronger gloss. Pressures between 5 bar and 300 bar can be used for homogenization, preferably between 25 bar and 225 bar, and particularly well between 50 bar and 250 bar. Homogenization can be in one or two stages.

The independent solutions and their mixture are preferably prepared under vacuum treatment, but not necessarily. The vacuum can prevent the formation of air bubbles in the egg.

According to the invention, each of the solutions ((A), (B), (C), and/or (D)) can be either pasteurized or sterilized. Pasteurization/sterilization can also be supplemented by other techniques, such as UV and/or high-pressure processing. These methods are standard techniques which are mastered by a person skilled in the art and are adequately described in the literature.

Solution (D) can be used as a liquid (e.g., as an ingredient in food/bakery products or for a scrambled egg). Surprisingly, an emulsion (e.g., mayonnaise) can also be produced with the egg substitute product, food can be prepared, a cake can be stabilized, and a scrambled egg can be produced.

The optimal amount of water depends to a certain extent on the exact composition of the egg substitute product. This can be determined in a simple manner by first mixing in a relatively small amount of water. If the liquid egg substitute product is then still thicker than desired, even more water can be mixed in. Thus, the viscosity of the egg substitute product is controlled by the addition of water to the aforementioned ingredients. The egg substitute product may have an initial viscosity (prior to any heat or other treatment), defined as resistance to deformation at a given shear rate, in the range between 0.5 Pa·s and 200.0 Pa·s, preferably 0.7 Pa·s-150 Pa·s; 1.51 Pa·s-100 Pa·s or 50 Pa·s-80 Pa·s. On the other hand, after a heat treatment (e.g., boiling), the egg can have a viscosity in the range of 100 Pa·s and 10,000 Pa·s, preferably 300 Pa·s-8,000 Pa·s, 700 Pa·s-3,500 Pa·s or 900 Pa·s-1,500 Pa·s. The viscosity can be measured by means of a rheometer (MCR301 SN802801740, Anton Paar GmbH, Graz, Austria) with a cylindrical measuring system (CC27-SN12031) with a measuring gap d=1.136 mm. The manner in which the viscosity measurement is to be carried out with a rheometer is known to a person skilled in the art. Only exemplary conditions are described below. The cylinder is filled, for example, with 15 ml of the sample. The sample is equilibrated for 5 minutes at 10° C. and left for measurement. The rotation is increased linearly from 2-100 s-1 within 60 s. The rotation of 100 s⁻¹ is maintained for 30 s before decreasing from 100-2 s-1 within 60 s. Viscosity is adjusted based on a given protein type and concentration by the addition of hydrocolloids, salt, and buffer salts and is carried out experimentally by measuring the viscosities.

A particularly preferred embodiment of the present invention comprises:

| | Quantity | Ranges |
|---|---|---|
| Ingredient | (wt. %) | (wt. %) |
| NaCl | 0.375 | 0.2-0.5 |
| Fava bean protein | 2.000 | 2.0-8.0 |
| Pea protein | 3.250 | 2.0-15.0 |
| Calcium lactate | 0.000 | 0.0-1.0 |
| Yam | 5.700 | 3.0-8.0 |
| Beta- | 0.070 | 0.05-2.25 |
| carotene/carrot | | |
| extract | | |
| Sunflower/ | 8.000 | 3.0-20.0 |
| rapeseed oil | | |
| Methylcellulose | 1.000 | 0.1-2.5 |
| Carrageen | 0.900 | 0.1-2.5 |
| Xanthan | 0.05 | 0.0-2.5 |
| Potassium chloride | 0.03 | 0.0-1.5 |
| Dextrose | 0.02 | 0.0-1.5 |
| Natural flavors | 1.000 | 0.0-2.5 |
| Vitamin D3 | 0.000001 | 0.0-0.001 |
| Vitamin B12 | 0.0000005 | 0.0-0.0005 |
| Water | Rest | Rest |
| | (78.205) | (32.25-89.55) |

The invention is further illustrated by the figures which show:

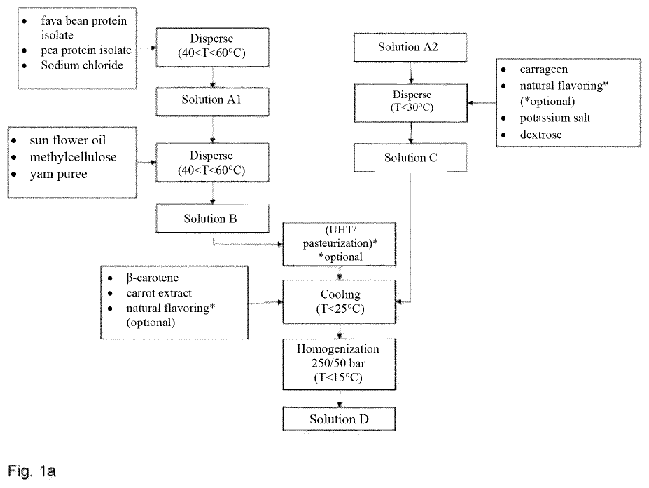

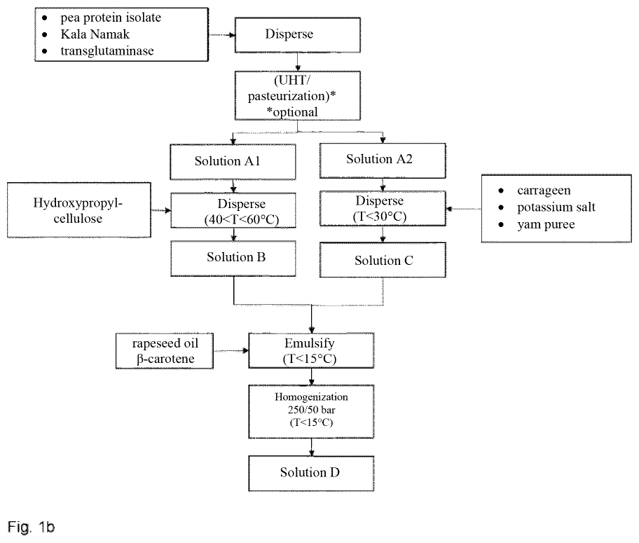

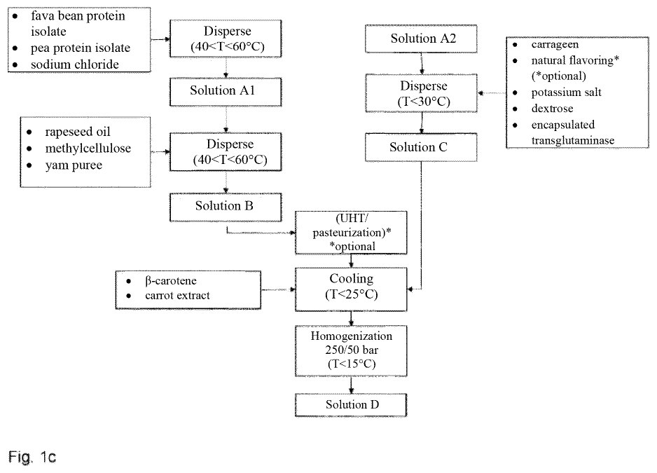

FIG. 1a: Diagram for the preparation of an egg substitute product according to Example 1

FIG. 1b: Diagram for the preparation of an egg substitute product according to Example 2

FIG. 1c: Diagram for the preparation of an egg substitute product according to Example 3

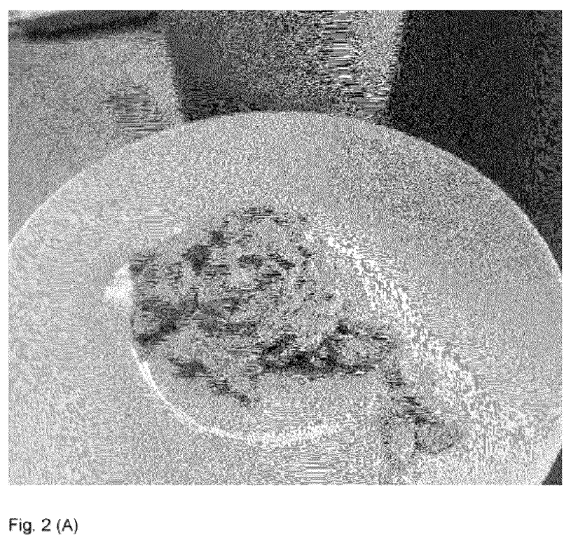

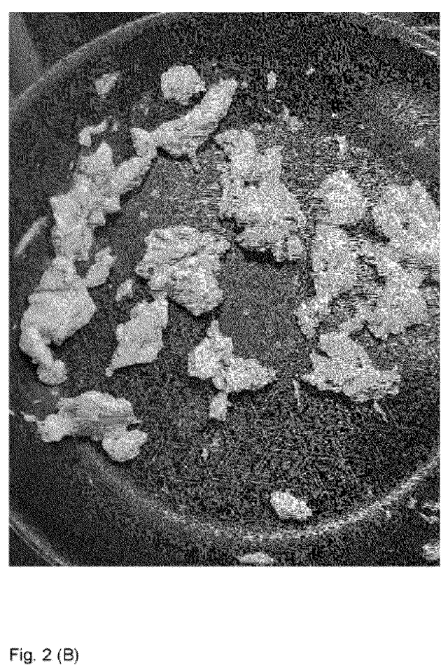

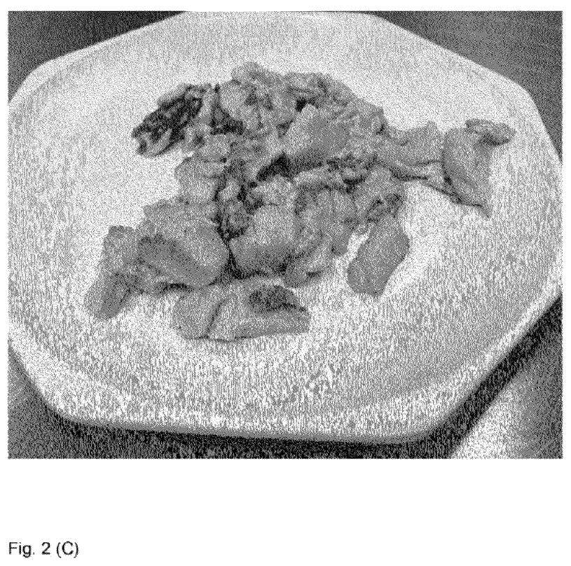

FIGS. 2 (A)-(C): Egg alternatives of Examples 1-3 as scrambled eggs and omelets simulating a chicken egg

The following examples describe egg substitute products according to the invention. These do not represent a limitation to these exact embodiments.

### EXAMPLE 1

| | |
|---|---|
| Water | 66.1% |
| Yam puree | 6% |
| Fava bean | 3.25% |
| protein isolate | |
| Pea protein isolate | 4.5% |
| Methylcellulose | 1.2% |
| Carrageen | 0.85% |
| Dextrose | 0.1% |
| Potassium chloride | 0.1% |
| Sodium chloride | 0.1% |
| Sunflower oil | 15% |
| β-carotene | 0.2% |
| Carrot extract | 0.75% |
| Natural flavor 1 | 1% |
| Natural flavor 2 | 0.85% |

Production takes place as shown in the diagram of FIG. 1a.

### EXAMPLE 2

| | |
|---|---|
| Water | 60.68% |
| Yam puree | 5.49% |
| Pea protein isolate | 5.55% |
| Fava bean | 4.60% |
| protein isolate | |
| Transglutaminase | 0.85% |
| Hydroxypropyl- | 1.00% |
| methylcellulose | |
| Carrageen | 0.90% |
| Potassium chloride | 0.10% |
| Kala Namak | 0.74% |
| Rapeseed oil | 20.0% |
| β-carotene | 0.09% |

Production takes place as shown in the diagram of FIG. 1b.

### EXAMPLE 3

| | |
|---|---|
| Water | 66.10% |
| Yam puree | 6.00% |
| Fava bean | 3.25% |
| protein isolate | |
| Pea protein isolate | 4.50% |
| Methylcellulose | 1.20% |
| Carrageen | 0.85% |
| Encapsulated | 0.60% |
| transglutaminase | |
| Dextrose | 0.10% |
| Potassium chloride | 0.10% |
| Sodium chloride | 0.10% |
| Rapeseed oil | 14.40% |
| β-carotene | 0.20% |
| Carrot extract | 0.75% |
| Natural flavor 1 | 1.00% |
| Natural flavor 2 | 0.85% |

Production takes place as shown in the diagram of FIG. 1c.

1) A vegan-based whole egg substitute product, comprising a mixture of:
(a) 1.0 wt. %-30.0 wt. % of a protein derived from pulses, oilseeds, cereals, algae, or microorganisms;
(b) 1.0 wt. %-30.0 wt. % of vegetable oil, optionally containing an emulsifier;
(c) 0.2 wt. %-5 wt. % of a combination of a reversibly thermogelling hydrocolloid selected from methylcellulose, hydroxyethylcellulose, and/or hydroxypropylcellulose with a reversibly gelling hydrocolloid(s) selected from carrageen and/or agar;
(d) 2.0 wt. %-15 wt. % of a carotenoid-containing food, wherein the carotenoid-containing food comprises yam in an amount of 2.0 wt %-10 wt %;
(e) optionally a partially pregelatinized starch;
(f) 0.2 wt. %-2.0 wt. % of salt;
(g) the rest being drinking water.

2) The whole egg substitute product according to claim 1, wherein the mixture further comprises a natural coloring substance in addition to the carotenoid-containing food.

3) The whole egg substitute product according to claim 1, wherein the mixture further comprises a salt or a flavoring formulation containing sulfur compounds or salts.

4) The whole egg substitute product according to claim 1, wherein the mixture further comprises a spice or flavoring formulation.

5) The whole egg substitute product according to claim 1, wherein the hydrocolloid (c) is a combination of methylcellulose and carrageenan.

6) The whole egg substitute product according to any one of claims 1-5, wherein the vegetable oil (b) is corn germ oil, rapeseed oil, coconut fat, and/or sunflower oil or any combinations thereof.

7) The whole egg substitute product according to claim 1, wherein the plant protein (a) is pea protein and/or fava bean protein.

8) The whole egg substitute product according to claim 1, wherein the plant protein is a (hydrolyzed) flour, protein concentrate, protein isolate, and/or any combinations thereof.

9) The whole egg substitute product according to claim 1, wherein the whole egg substitute product has a protein content of between 4 wt. % and 25 wt. %.

10) The whole egg substitute product according to claim 1, wherein the whole egg substitute product has a fat content between 3 wt. % and 20 wt. %.

11) The whole egg substitute product according to claim 1, wherein the vegetable oil contains an emulsifier selected from lecithin, ascorbyl palmitate, sodium phosphate, potassium phosphate, propylene glycol alginate, polyoxyethyl stearate, ammonium phosphatides, acetic acid monoglycerides, lactic acid monoglycerides, citric acid monoglycerides, tartaric acid monoglycerides, stearyl tartrate, or sorbitan monostearate.

12) The whole egg substitute product according to claim 1, wherein the product has the following composition:

| | Quantity |
|---|---|
| Ingredient | (wt. %) |
| NaCl | 0.2-0.5 |
| Fava bean protein | 2.0-8.0 |
| Pea protein | 2.0-15.0 |
| Calcium lactate | 0.0-1.0 |
| Yam | 3.0-8.0 |
| Beta-carotene/ | 0.05-2.25 |
| carrot extract | |
| Sunflower oil/ | 3.0-20.0 |
| rapeseed oil | |
| Methylcellulose | 0.1-2.5 |
| Carrageen | 0.1-2.5 |
| Xanthan | 0.0-2.5 |
| Potassium chloride | 0.0-1.5 |
| Dextrose | 0.0-1.5 |
| Natural flavors | 0.0-2.5 |
| Vitamin D3 | 0.0-0.001 |
| Vitamin B12 | 0.0-0.0005 |
| Water | Rest |
| | (32.25-89.55) |

13) The whole egg substitute product according to claim 12, wherein the product has the following composition

| | Quantity |
|---|---|
| Ingredient | (wt. %) |
| Water | 78.205 |
| NaCl | 0.375 |
| Fava bean protein | 2.000 |
| Pea protein | 3.250 |
| Calcium lactate | 0.000 |
| Yam | 5.700 |
| Beta-carotene/ | 0.070 |
| carrot extract | |
| Sunflower oil/ | 8.000 |
| rapeseed oil | |
| Methylcellulose | 1.000 |
| Carrageen | 0.900 |
| Xanthan | 0.05 |
| Potassium chloride | 0.03 |
| Dextrose | 0.02 |
| Natural flavors | 0.400 |
| Vitamin D3 | 0.000001 |
| Vitamin B12 | 0.0000005 |

14) A method for preparing a whole egg substitute product according to claim 1, comprising the following steps:
(a1) dispersing a plant protein in drinking water or an aqueous sodium chloride solution to produce a protein solution (A) and dividing the protein solution (A) into two parts (A1) and (A2), or
(a2) dispersing a plant protein in drinking water or an aqueous sodium chloride solution to produce a protein solution (A1) and producing a solution (A2) containing either drinking water alone or a second plant protein dissolved in drinking water,
(b) preparing a solution (B) by mixing the protein solution (A1) with a thermogelling hydrocolloid selected from methylcellulose, hydroxyethylcellulose and/or hydroxypropylcellulose at least 40° C.,
(c) preparing a solution (C) by mixing the solution (A2) with a reversibly gelling hydrocolloid selected from carrageen and/or agar at room temperature or at a temperature up to 30° C.,
(d) adding a vegetable oil plus optional emulsifier to solution (B) and/or (C) under continuous stirring and, optionally, homogenization,
(e) adding a carotenoid-containing food containing yam and optionally other natural coloring substances or additives to solution (B) and/or (C),
(f) mixing solutions (B) and (C) to obtain the solution (D).

15) The method according to claim 14, wherein a salt is added to solution (C).

16) The method according to claim 14, wherein the natural coloring substance in step (e) is β-carotene.

17) A component of an emulsion or a liquid comprising at least one phase as an ingredient in a food or bakery product comprising the whole egg substitute product of claim 1.

18) The component according to claim 17, wherein the component is a vegan emulsion or a liquid comprising at least one phase, as an ingredient in a vegan food or vegan bakery product.

19) The component according to claim 17, wherein the component is a non-vegan emulsion or a liquid comprising at least one phase, as an ingredient in a non-vegan food or non-vegan bakery product.
